(19) United States
(12) Patent Application Publication
(10) Pub. No.: US 2025/0101216 A1
(43) Pub. Date: Mar. 27, 2025

(54) ARTICLES COMPRISING ETHYLENE-BASED POLYMER, POLYOLEFIN, SILANE CROSSLINKER, AND METALLIC STEARATE CATALYST

(71) Applicant: Avient Corporation, Avon Lake, OH (US)

(72) Inventors: Shu LIU, Lake in the Hills, IL (US); Liang XU, Vernon Hills, IL (US); Yannan DUAN, Farmington, CT (US)

(73) Assignee: Avient Corporation, Avon Lake, OH (US)

(21) Appl. No.: 18/723,151

(22) PCT Filed: Dec. 22, 2022
(86) PCT No.: PCT/US2022/053754

§ 371 Date: Jun. 21, 2024

Related U.S. Application Data
(60) Provisional application No. 63/293,336, filed on Dec. 23, 2021.

(51) Int. Cl. C08L 51/08; C08F 4/08; C08F 287/00; C08K 5/01; C08K 5/14; C08K 5/5425; C08L 23/0807

(52) U.S. Cl. CPC C08L 51/08; C08F 4/08; C08F 287/00; C08K 5/01; C08K 5/14; C08K 5/5425; C08L 23/0815; C08L 2312/08

(57) ABSTRACT

Embodiments of the present disclosure are directed to articles comprising a crosslinked reaction product of ethyl-ene-based polymer, polyolefin; silane crosslinker; and 1 to 5 weight percent (wt %) of a metallic stearate catalyst. The ethylene-based polymer is silane grafted. The grafted silane enables at least one intramolecular silane crosslinking of the ethylene-based polymer and intermolecular silane crosslinking of the ethylene-based polymer and the polyolefin.

### CLAIM OF PRIORITY

This application claims the benefit of U.S. Provisional Patent Application Ser. No. 63/293,336 bearing Attorney Docket Number 1202109 and filed on Dec. 23, 2021, which is hereby incorporated by reference in its entirety.

### TECHNICAL FIELD

Embodiments of the present disclosure are generally related to articles, and are specifically related to articles of ethylene-based polymer, polyolefin, silane crosslinker, and metallic stearate catalyst.

### BACKGROUND

Silane-crosslinked thermoplastic elastomers are widely used in a variety of applications, including fibers, seals, gaskets, tubes, pipes, bellows, and tapes. Conventional silane-crosslinked thermoplastic elastomers are formed using and may contain tin-based catalyst, such as dibutyltin dilaurate. However, in medical, healthcare, or food contact applications, it may be desirable to use non-tin based catalysts.

Accordingly, a continual need exists for articles crosslinked using a non-tin based catalyst.

### SUMMARY

Embodiments of the present disclosure are directed to articles comprising a crosslinked reaction product of ethylene-based polymer, polyolefin, silane crosslinker, and metallic stearate catalyst, which exhibit sufficient compression set (i.e., less than 90% as measured at 125° C. or less than or equal to 95% as measured at 150° C.) and may be desired in medical, healthcare, and food applications.

According to one embodiment, an article is provided. The article comprises a crosslinked reaction product of olefin block copolymer (OBC), polyolefin, silane crosslinker, and metallic stearate catalyst. The OBC is silane grafted. The grafted silane enables at least one of intramolecular silane crosslinking of the OBC and intermolecular silane crosslinking of the OBC and the polyolefin.

According to other embodiments, an article is provided. The article comprises a crosslinked reaction product of ethylene-based polymer, polyolefin, silane crosslinker, and metallic stearate catalyst. The ethylene-based polymer comprises polyolefin elastomer (POE), high-density polyethylene (HDPE), low-density polyethylene (LDPE), linear low-density polyethylene (LLDPE), polyethylene, or a combination thereof. The ethylene-based polymer is silane grafted. The grafted silane enables at least one of intramolecular silane crosslinking of the ethylene-based polymer and intermolecular silane crosslinking of the ethylene-based polymer and the polyolefin.

Additional features and advantages of the embodiments described herein will be set forth in the detailed description which follows, and in part will be readily apparent to those skilled in the art from that description or recognized by practicing the embodiments described herein, including the detailed description, which follows and the claims.

### DETAILED DESCRIPTION

Reference will now be made in detail to various embodiments of articles, specifically articles comprising a crosslinked reaction product of olefin block copolymer (OBC), polyolefin, silane crosslinker, and metallic stearate catalyst. The OBC is silane grafted. The grafted silane enables at least one of intramolecular silane crosslinking of the OBC and intermolecular silane crosslinking of the OBC and the polyolefin.

Reference will also be made to articles comprising a crosslinked reaction product of ethylene-based polymer, polyolefin, silane crosslinker, and metallic stearate catalyst. The ethylene-based polymer comprises polyolefin elastomer (POE), high-density polyethylene (HDPE), low-density polyethylene (LDPE), linear low-density polyethylene (LLDPE), polyethylene, or a combination thereof. The ethylene-based polymer is silane grafted. The grafted silane enables at least one of intramolecular silane crosslinking of the ethylene-based polymer and intermolecular silane crosslinking of the ethylene-based polymer and the polyolefin.

The disclosure should not be construed as limited to the embodiments set forth herein. Rather, these embodiments are provided so that this disclosure will be thorough and complete, and will fully convey the subject matter to those skilled in the art.

### Definitions

Unless otherwise defined, all technical and scientific terms used herein have the same meaning as commonly understood by one of ordinary skill in the art. The terminology used in the disclosure herein is for describing particular embodiments only and is not intended to be limiting.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used in the specification and the appended claims, the singular forms “a,” “an,” and “the” are intended to include the plural forms as well, unless the context clearly indicates otherwise. Thus, for example, reference to “a” component includes aspects having two or more such components, unless the context clearly indicates otherwise.

The term “wt %,” as described herein, refers to the weight fraction of the individual reactants of the formulation used to produce the crosslinked reaction product that comprises the article, unless otherwise noted. For simplicity purposes, “wt %” will be referred to throughout as the amount in the article.

The term “hardness,” as described herein, refers to the Shore A hardness of a material as measured according to ASTM D2240.

The term “specific gravity,” as described herein, refers to the ratio of the density of a material to the density of water as measured according to ASTM D792.

The term “100% modulus,” as described herein, refers to the force at 100% tensile elongation as measured according to ASTM D638 at 23° C. and a rate of strain of 20 in/min.

The term “tensile strength,” as described herein, refers to the maximum stress that a material can withstand while stretching before breaking as measured according to ASTM D638 at 23° C. and a rate of strain of 20 in/min.

The term “tensile elongation,” as described herein, refers to the ratio between increased length and initial length after breakage as measured according to ASTM D638 at 23° C. and a rate of strain of 20 in/min.

The term “compression set,” as described herein, refers to the ability of a material to return to its original thickness after prolonged compressive stress as measured according to ASTM D395 at the temperature and time period indicated.

The term “sufficient compression set,” as described herein, refers to a compression set less than 90% as measured at 125° C. or less than or equal to 95% as measured at 150° C.

The term “silane grafted,” as described herein, refers to the ethylene-based polymer having a silane side chain connected to the polymer main chain. The grafted silane allows at least one of intramolecular crosslinking of the ethylene-based polymer and intermolecular silane crosslinking of the ethylene-based polymer and the polyolefin.

The term “intramolecular silane crosslinking,” as described herein, refers to silane crosslinking that occurs when the ethylene-based polymer crosslinks with itself.

The term “intermolecular silane crosslinking,” as described herein, refers to silane crosslinking that occurs when the ethylene-based polymer crosslinks with the polyolefin.

The term “copolymer,” as described herein, refers to a polymer formed when two or more different monomers are linked in the same chain.

The term “block,” as described herein, refers to a portion of a macromolecule, comprising many constitutional units, that has at least one feature which is not present in the adjacent portions.

The term “olefin block copolymer (OBC),” as described herein, refers to a polymer comprising a plurality of blocks or segments, each comprising an ethylene or propylene repeating unit and an alpha-olefin repeating unit in different mole fractions.

The term “polyolefin,” as described herein, refers a polymer that includes mer units from the polymerization of one or more olefin monomers and that forms a highly crystalline arrangement (i.e., greater than or equal to 40% crystalline) including a thermoplastic domain, an amorphous elastomer or rubber domain. The polyolefin may be obtained, commercially, as a single species of polyolefin or a blend of two or more polyolefins, and may optionally include a filler.

The term “polyolefin elastomer (POE),” as described herein, refers a polymer that includes mer units from the polymerization of one or more olefin monomers and that forms a low crystalline arrangement (i.e., less than or equal to 25% crystalline) including a thermoplastic domain, an amphorous elastomer or rubber domain. The polyolefin elastomer may be obtained, commercially, as a single species of polyolefin elastomer or a blend of two or more polyolefin elastomers, and may optionally include a filler.

The term “ethylene alpha-olefin copolymer,” as described herein, refers to an ethylene alpha-olefin copolymer comprising C3-C12 olefins.

As discussed hereinabove, tin-based catalysts are widely used in the production of silane-crosslinked thermoplastic elastomers. However, in medical, healthcare, or food contact applications, it may be desirable to use non-tin based catalysts.

Disclosed herein are articles which mitigate the aforementioned problems. Specifically, the articles disclosed herein include a metallic stearate catalyst, which may provide more opportunities for the use of silane-crosslinked thermoplastic elastomers in the medical, healthcare, and food fields as compared to conventional tin-based catalysts. Moreover, as evidenced by sufficient compression set, a metallic stearate catalyst leads to crosslinking of the thermoplastic elastomer.

The articles disclosed herein may generally be described as the crosslinked reaction product of ethylene-based polymer, polyolefin, silane crosslinker, and metallic stearate catalyst. These articles exhibit sufficient compression set and may be desired in medical, healthcare, and food applications.

### Ethylene-Based Polymer

As described hereinabove, the article includes ethylene-based polymer, which is silane grafted and crosslinks with itself, or co-crosslinks with polyolefin due to the mixing thereof.

In embodiments, the ethylene-based polymer may comprise polyolefin elastomer (POE), high-density polyethylene (HDPE), low-density polyethylene (LDPE), linear low-density polyethylene (LLDPE), polyethylene, or a combination thereof. In embodiments, the POE may comprise olefin block copolymer (OBC), ethylene alpha-olefin copolymer, or both.

### Olefin Block Copolymer (OBC)

As described hereinabove, in embodiments, the article may include OBC, which is silane grafted and crosslinks with itself, or co-crosslinks with the polyolefin due to the mixing thereof.

Various OBC are considered suitable for the present articles. In embodiments, the OBC may comprise an ethylene alpha-olefin repeating unit. The ethylene alpha-olefin repeating unit is the polymerized reaction product of ethylene and C₃-C₁₂ olefins. For example, in embodiments, the ethylene alpha-olefin repeating unit may comprise ethylene-octene copolymer, ethylene-hexene copolymer, ethylene-butene copolymer, or a combination thereof.

In embodiments, the OBC may have a melt flow rate (190° C./2.16 kg) greater than or equal to 1 g/10 min or even greater than or equal to 5 g/10 min. In embodiments, the OBC may have a melt flow rate (190° C./2.16 kg) less than or equal to 25 g/10 min or even less than or equal to 20 g/10 min. In embodiments, the OBC may have a melt flow rate (190° C./2.16 kg) from 1 g/10 min to 25 g/10 min, from 1 g/10 min to 20 g/10 min, from 5 g/10 min to 25 g/10 min, or even from 5 g/10 min to 20 g/10 min, or any and all sub-ranges formed from any of these endpoints.

In embodiments, the OBC may have a density greater than or equal to 0.80 g/cm³ or even greater than or equal to 0.85 g/cm³. In embodiments, the OBC may have a density less than or equal to 0.95 g/cm³ or even less than or equal to 0.90 g/cm³. In embodiments, the OBC may have a density from 0.80 g/cm³ to 0.95 g/cm³, from 0.80 g/cm³ to 0.90 g/cm³, from 0.85 g/cm³ to 0.95 g/cm³, or even from 0.85 g/cm³ to 0.90 g/cm³, or any and all sub-ranges formed from any of these endpoints.

In embodiments, the OBC may have a tensile strength greater than or equal to 1 MPa or even greater than or equal to 5 MPa. In embodiments, the OBC may have a tensile strength less than or equal to 15 MPa or even less than or equal to 10 MPa. In embodiments, the OBC may have a tensile strength from 1 MPa to 15 MPa, from 1 MPa to 10 MPa, from 5 MPa to 15 MPa, or even from 5 MPa to 10 MPa, or any and all sub-ranges formed from any of these endpoints.

In embodiments, the OBC may have a tensile elongation greater than or equal to 1250% or even greater than or equal to 1500%. In embodiments, the OBC may comprise a tensile elongation less than or equal to 2000% or even less than or equal to 1750%. In embodiments, the OBC may have a tensile elongation from 1250% to 2000%, from 1250% to 1750%, from 1500% to 2000%, or even from 1500% to 1750%, or any and all sub-ranges formed from any of these endpoints.

In embodiments, the OBC may have a Shore A hardness greater than or equal to 50 or even greater than or equal to 60. In embodiments, the OBC may have a Shore A hardness less than or equal to 85 MPa or even less than or equal to 75 MPa. In embodiments, the OBC may have a Shore A hardness from 50 to 85, from 50 to 75, from 60 to 85, or even from 60 to 75, or any and all sub-ranges formed from any of these endpoints.

In embodiments, the OBC may have a compression set less than or equal to 70%, less than or equal to 65%, or even less than or equal to 60% as measured at 70° C.

In embodiments, the amount of OBC in the article may be less than or equal to 85 wt %, less than or equal to 70 wt %, less than or equal to 55 wt %, or even less than or equal to 40 wt %. In embodiments, the amount of OBC in the article may be greater than or equal to 10 wt %, greater than or equal to 15 wt %, greater than or equal to 20 wt %, or even greater than or equal to 25 wt %. In embodiments, the amount of OBC in the article may be from 10 wt % to 85 wt %, from 10 wt % to 70 wt %, from 10 wt % to 55 wt %, from 10 wt % to 40 wt %, from 15 wt % to 85 wt %, from 15 wt % to 70 wt %, from 15 wt % to 55 wt %, from 15 wt % to 40 wt %, from 20 wt % to 85 wt %, from 20 wt % to 70 wt %, from 20 wt % to 55 wt %, from 20 wt % to 40 wt %, from 25 wt % to 85 wt %, from 25 wt % to 70 wt %, from 25 wt % to 55 wt %, or even from 25 wt % to 40 wt %, or any and all sub-ranges formed from any of these endpoints.

Suitable commercial embodiments of OBC are available under the Infuse brand, such as 9000, 9500 and 9817, from Dow Chemical Company.

### Ethylene Alpha-Olefin Copolymer

As described hereinabove, in embodiments, the article may include ethylene alpha-olefin copolymer, which is silane grafted and crosslinks with itself, or co-crosslinks with the polyolefin due to the mixing thereof.

The ethylene alpha-olefin copolymer is the polymerized reaction product of ethylene and C₃-C₁₂ olefins. For example, in embodiments, the ethylene alpha-olefin copolymer may comprise ethylene-octene copolymer, ethylene-hexene copolymer, ethylene-butene copolymer, or a combination thereof.

In embodiments, the ethylene alpha-olefin copolymer may have a melt flow rate (190° C./2.16 kg) greater than or equal to 0.2 g/10 min, greater than or equal to 1 g/10 min, greater than or equal to 10 g/10 min, or even greater than or equal to 25 g/10 min. In embodiments, the ethylene alpha-olefin copolymer may have a melt flow rate (190° C./2.16 kg) less than or equal to 100 g/10 min, less than or equal to 75 g/10 min, or even less than or equal to 50 g/10 min. In embodiments, the ethylene alpha-olefin copolymer may have a melt flow rate (190° C./2.16 kg) from 0.2 g/10 min to 100 g/10 min, from 0.2 g/10 min to 75 g/10 min, from 0.2 g/10 min to 50 g/10 min, from 1 g/10 min to 100 g/10 min, from 1 g/10 min to 75 g/10 min, from 1 g/10 min to 50 g/10 min, from 10 g/10 min to 100 g/10 min, from 10 g/10 min to 75 g/10 min, from 10 g/10 min to 50 g/10 min, from 25 g/10 min to 100 g/10 min, from 25 g/10 min to 75 g/10 min, or even from 25 g/10 min to 50 g/10 min, or any and all sub-ranges formed from any of these endpoints.

In embodiments, the ethylene alpha-olefin copolymer may have a density greater than or equal to 0.80 g/cm³ or even greater than or equal to 0.85 g/cm³. In embodiments, the ethylene alpha-olefin copolymer may have a density less than or equal to 0.95 g/cm³ or even less than or equal to 0.90 g/cm³. In embodiments, the ethylene alpha-olefin copolymer may have a density from 0.80 g/cm³ to 0.95 g/cm³, from 0.80 g/cm³ to 0.90 g/cm³, from 0.85 g/cm³ to 0.95 g/cm³, or even from 0.85 g/cm³ to 0.90 g/cm³, or any and all sub-ranges formed from any of these endpoints.

In embodiments, the ethylene alpha-olefin copolymer may have a tensile strength greater than or equal to 1 MPa or even greater than or equal to 5 MPa. In embodiments, the ethylene alpha-olefin copolymer may have a tensile strength less than or equal to 15 MPa or even less than or equal to 10 MPa. In embodiments, the ethylene alpha-olefin copolymer may have a tensile strength from 1 MPa to 15 MPa, from 1 MPa to 10 MPa, from 5 MPa to 15 MPa, or even from 5 MPa to 10 MPa, or any and all sub-ranges formed from any of these endpoints.

In embodiments, the ethylene alpha-olefin copolymer may have a tensile elongation greater than or equal to 100%, greater than or equal to 500%, or even greater than or equal to 1000%. In embodiments, the ethylene alpha-olefin copolymer may comprise a tensile elongation less than or equal to 2000% or even less than or equal to 1500%. In embodiments, the ethylene alpha-olefin copolymer may have a tensile elongation from 100% to 2000%, from 100% to 1500%, from 500% to 2000%, from 500% to 1500%, from 1000% to 2000%, or even from 1000% to 1500%, or any and all sub-ranges formed from any of these endpoints.

In embodiments, the ethylene alpha-olefin copolymer may have a Shore A hardness greater than or equal to 50 or even greater than or equal to 60. In embodiments, the ethylene alpha-olefin copolymer may have a Shore A hardness less than or equal to 95 MPa or even less than or equal to 85 MPa. In embodiments, the ethylene alpha-olefin copolymer may have a Shore A hardness from 50 to 95, from 50 to 85, from 60 to 95, or even from 60 to 85, or any and all sub-ranges formed from any of these endpoints.

In embodiments, the ethylene alpha-olefin copolymer may have a compression set less than or equal to 85%, less than or equal to 80%, or even less than or equal to 75% as measured at 70° C.

In embodiments, the amount of ethylene alpha-olefin copolymer in the article may be less than or equal to 85 wt %, less than or equal to 70 wt %, less than or equal to 55 wt %, or even less than or equal to 40 wt %. In embodiments, the amount of ethylene alpha-olefin copolymer in the article may be greater than or equal to 10 wt %, greater than or equal to 15 wt %, greater than or equal to 20 wt %, or even greater than or equal to 25 wt %. In embodiments, the amount of ethylene alpha-olefin copolymer in the article may be from 10 wt % to 85 wt %, from 10 wt % to 70 wt %, from 10 wt % to 55 wt %, from 10 wt % to 40 wt %, from 15 wt % to 85 wt %, from 15 wt % to 70 wt %, from 15 wt % to 55 wt %, from 15 wt % to 40 wt %, from 20 wt % to 85 wt %, from 20 wt % to 70 wt %, from 20 wt % to 55 wt %, from 20 wt % to 40 wt %, from 25 wt % to 85 wt %, from 25 wt % to 70 wt %, from 25 wt % to 55 wt %, or even from 25 wt % to 40 wt %, or any and all sub-ranges formed from any of these endpoints.

Suitable commercial embodiments of ethylene alpha-olefin copolymer are available under the Solumer brand, such as 851T, from SK Chemicals Co., Ltd.

### Polyolefin

In embodiments, the article may comprise polyolefin to assist with processability and adjustment of article properties (e.g., hardness). Polyolefin may co-crosslink with the ethylene-based polymer due to the mixing thereof.

Various polyolefins are considered suitable for the present articles. In embodiments, the polyolefin may comprise a propylene-based polyolefin. In embodiments, the polyolefin may comprise polypropylene (PP). In embodiments, the PP may comprise a polypropylene homopolymer (i.e., composed of propylene monomers) or a polypropylene copolymer having greater than 50 wt % propylene monomer and an additional comonomer such as C₂ and C₄-C₁₂ alpha olefins

In embodiments, the polypropylene may have a melt flow rate (230° C./2.16 kg) greater than or equal to 0.1 g/10 min, greater than or equal to 0.5 g/10 min, greater than or equal to 1 g/10 min, greater than or equal to 5 g/10 min, greater than or equal to 10 g/10 min, or even greater than or equal to 20 g/10 min. In embodiments, the polypropylene may have a melt flow rate (230° C./2.16 kg) less than or equal to 50 g/10 min, less than or equal to 40 g/10 min, less than or equal to 30 g/10 min, less than or equal to 20 g/10 min, or even less than or equal to 10 g/10 min. In embodiments, the polypropylene may have a melt flow rate (230° C./2.16 kg) from 0.1 g/10 min to 50 g/10 min, from 0.1 g/10 min to 40 g/10 min, from 0.1 g/10 min to 30 g/10 min, from 0.1 g/10 min to 20 g/10 min, from 0.1 g/10 min to 10 g/10 min, from 0.5 g/10 min to 50 g/10 min, from 0.5 g/10 min to 40 g/10 min, from 0.5 g/10 min to 30 g/10 min, from 0.5 g/10 min to 20 g/10 min, from 0.5 g/10 min to 10 g/10 min, from 1 g/10 min to 50 g/10 min, from 1 g/10 min to 40 g/10 min, from 1 g/10 min to 30 g/10 min, from 1 g/10 min to 20 g/10 min, from 1 g/10 min to 10 g/10 min, from 5 g/10 min to 50 g/10 min, from 5 g/10 min to 40 g/10 min, from 5 g/10 min to 30 g/10 min, from 5 g/10 min to 20 g/10 min, from 5 g/10 min to 10 g/10 min, from 10 g/10 min to 50 g/10 min, from 10 g/10 min to 40 g/10 min, from 10 g/10 min to 30 g/10 min, from 10 g/10 min to 20 g/10 min, from 20 g/10 min to 50 g/10 min, from 20 g/10 min to 40 g/10 min, or even from 20 g/10 min to 30 g/10 min, or any and all sub-ranges formed from any of these endpoints.

In embodiments, the polyolefin may comprise a density greater than or equal to 0.8 g/cm³ or even greater than or equal to 0.85 g/cm³. In embodiments, the polyolefin may comprise a density less than or equal to 1.10 g/cm³ or even less than or equal to 1.00 g/cm³. In embodiments, the polyolefin may comprise a density from 0.80 g/cm³ to 1.10 g/cm³, from 0.80 g/cm³ to 1.00 g/cm³, from 0.85 g/cm³ to 1.10 g/cm³, or even from 0.85 g/cm³ to 1.00 g/cm³, or any and all sub-ranges formed from any of these endpoints.

In embodiments, the polyolefin may have a melting point greater than or equal to 100° C., greater than or equal to 110° C., or even greater than or equal to 120° C.

In embodiments, the amount of polyolefin in the article may be less than or equal to 30 wt %, less than or equal to 25 wt %, less than or equal to 20 wt %, less than or equal to 15 wt %, or even less than or equal to 10 wt %. In embodiments, the amount of polyolefin in the article may be greater than or equal to 1 wt %, greater than or equal to 2 wt %, greater than or equal to 2 wt %, or even greater than or equal to 6 wt %. In embodiments, the amount of polyolefin in the article may be from 1 wt % to 30 wt %, from 1 wt % to 25 wt %, from 1 wt % to 20 wt %, from 1 wt % to 15 wt %, from 1 wt % to 10 wt %, from 2 wt % to 30 wt %, from 2 wt % to 25 wt %, from 2 wt % to 20 wt %, from 2 wt % to 15 wt %, from 2 wt % to 10 wt %, from 4 wt % to 30 wt %, from 4 wt % to 25 wt %, from 4 wt % to 20 wt %, from 4 wt % to 15 wt %, from 4 wt % to 10 wt %, from 6 wt % to 30 wt %, from 6 wt % to 25 wt %, from 6 wt % to 20 wt %, from 6 wt % to 15 wt %, or even from 6 wt % to 10 wt %, or any and all sub-ranges formed from any of these endpoints.

Suitable commercial embodiments of the polyolefin are available under the FORMOLENE brand, such as polypropylene homopolymer 1102KR, from Formosa Plastics; and under the PRO-FAX brand, such as polyprolyene homopolymer PD702, from LyondellBasell.

### Silane Crosslinker

As stated hereinabove, the ethylene-based polymer is silane grafted and the grafted silane enables at least one of intramolecular silane crosslinking of the ethylene-based polymer and intermolecular silane crosslinking of the ethylene-based polymer and the polyolefin.

Various silane crosslinkers are considered suitable for the present articles. In embodiments, the silane crosslinker may comprise vinyl trialkoxysilane. For example, in embodiments, the silane crosslinker may comprise vinyl trimethoxysilane, vinyl triethoxysilane, p-styryl trimethoxy silane, methylvinyldimethoxysilane, vinyldimethyl methoxysilane, divinyldimethoxysilane, vinyltris (2 methoxyethoxy) silane, vinylbenzylethylenediaminopropyltrimethoxysilane, or a combination thereof.

In embodiments, the silane crosslinker may have a specific gravity greater than or equal to 0.9 or even greater than or equal to 0.95. In embodiments, the silane crosslinker may have a specific gravity less than or equal to 1.05 or even less than or equal to 1. In embodiments, the silane crosslinker may have a specific gravity from 0.9 to 1.05, from 0.9 to 1, from 0.95 to 1.05, or even from 0.95 to 1, or any and all sub-ranges formed from any of these endpoints.

In embodiments, the silane crosslinker may have a boiling point greater than or equal to 75° C. or even greater than or equal to 100° C. In embodiments, the silane crosslinker may have a boiling point less than or equal to 150° C. or even less than or equal to 125° C. In embodiments, the silane crosslinker may have a boiling point from 75° C. to 150° C., from 75° C. to 125° C., from 100° C. to 150° C., or even from 100° C. to 125° C., or any and all sub-ranges formed from any of these endpoints.

In embodiments, the silane crosslinker is included in an amount greater than or equal to 0.5 wt % to enable at least one of intramolecular silane crosslinking of the ethylene-based polymer and intermolecular silane crosslinking of the ethylene-based polymer and the polyolefin. In embodiments, the amount of silane crosslinker in the article may be greater than or equal to 0.1 wt %, greater than or equal to 0.5 wt %, or even greater than or equal to 1 wt %. In embodiments, the amount of silane crosslinker in the article may be less than or equal to 4 wt %, less than or equal to 3.5 wt %, less than or equal to 3 wt %, or even less than or equal to 2.5 wt %. In embodiments, the amount of silane crosslinker in the article may be from 0.1 wt % to 4 wt %, from 0.1 wt % to 3.5 wt %, from 0.1 wt % to 3 wt %, from 0.1 wt % to 2.5 wt %, from 0.5 wt % to 4 wt %, from 0.5 wt % to 3.5 wt %, from 0.5 wt % to 3 wt %, from 0.5 wt % to 2.5 wt %, from 1 wt % to 4 wt %, from 1 wt % to 3.5 wt %, from 1 wt % to 3 wt %, or even from 1 wt % to 2.5 wt %, or any and all sub-ranges formed from any of these endpoints.

Suitable commercial embodiments of the silane crosslinker are available under the SILQUEST brand, such as A-171, from Momentive.

In embodiments, the silane crosslinker may be included in a solution comprising organic peroxide such that the silane crosslinker is better dispersed within ethylene-based polymer, leading to improved silane grafting.

In embodiments, the organic peroxide may comprise di-t-butyl peroxide; t-butyl cumyl peroxide; dicumyl peroxide; 1,3-bis (t-butyl peroxy-isopropyl) benzene; n-butyl-4,4-bis (t-butyl-peroxy) valerate; benzoyl peroxide; t-butylperoxybenzoate; t-butylperoxy isopropyl carbonate; t-butylperbenzoate; bis(2-methylbenzoyl) peroxide; bis(4-methylbenzoyl) peroxide; t-butyl peroctoate; cumene hydroperoxide; methyl ethyl ketone peroxide; lauryl peroxide; tert-butyl peracetate; di-t-amyl peroxide; t-amyl peroxybenzoate; 1,1-bis (t-butylperoxy)-3,3,5-trimethylcyclohexane; 2,5-bis (t-butylperoxy)-2,5 dimethylhexane; 2,5-bis (t-butylperoxy)-2,5-dimethyl-3-hexyne; 2,4-dichlorobenzoyl peroxide; or a combination thereof.

In embodiments, the organic peroxide may have a density greater than or equal to 1.00 g/cm³ or even greater than or equal to 1.05 g/cm³. In embodiments, the organic peroxide may have a density less than or equal to 1.20 g/cm³ or even less than or equal to 1.15 g/cm³. In embodiments, the organic peroxide may have a density from 1.00 g/cm³ to 1.20 g/cm³, from 1.00 g/cm³ to 1.15 g/cm³, from 1.05 g/cm³ to 1.20 g/cm³, or even from 1.05 g/cm³ to 1.15 g/cm³, or any and all sub-ranges formed from any of these endpoints.

In embodiments, the organic peroxide may have a boiling point greater than or equal to 75° C. or even greater than or equal to 100° C. In embodiments, the organic peroxide may have a boiling point less than or equal to 150° C. or even less than or equal to 125° C. In embodiments, the organic peroxide may have a boiling point from 75° C. to 150° C., from 75° C. to 125° C., from 100° C. to 150° C., or even from 100° C. to 125° C., or any and all sub-ranges formed from any of these endpoints.

In embodiments, the amount of organic peroxide in the article may be greater than or equal to 0.001 wt %, greater than or equal to 0.01 wt %, or even greater than or equal to 0.1 wt %. In embodiments, the amount of organic peroxide in the article may be less than or equal to 5 wt %, less than or equal to 2 wt %, or even less than or equal to 0.5 wt %. In embodiments, the amount of organic peroxide in the article may be from 0.001 wt % to 5 wt %, from 0.01 wt % to 2 wt %, or even from 0.1 wt % to 1 wt %, or any and all sub-ranges formed from any of these endpoints.

Suitable commercial embodiments of the organic peroxide are available under the PERKADOX brand, such as BC-FF, from AkzoNobel.

### Metallic Stearate Catalyst

In embodiments, the article may comprise a metallic stearate catalyst to initiate silane crosslinking of the ethylene-based polymer and/or the ethylene-based polymer and polyolefin, as evidenced by sufficient compression set. Moreover, a metallic stearate catalyst may lead to more opportunities for use of a silane-crosslinked thermoplastic elastomer in medical, healthcare, and food applications as compared to a tin-based catalyst.

In embodiments, the metallic stearate catalyst may comprise zinc stearate, lithium stearate, calcium stearate, sodium stearate, or a combination thereof.

In embodiments, the metallic stearate catalyst is blended with the ethylene-based polymer, polyolefin, and the silane crosslinker during silane grafting. In embodiments, the metallic stearate catalyst is added to the extruded or molded formulation, wherein ethylene-based polymer is silane grafted. The ethylene-based polymer is silane grafted may crosslink upon exposure to moisture (e.g., air).

In embodiments, the amount of metallic stearate catalyst in the article may be greater than or equal to 1 wt %, greater than or equal to 1.25 wt %, or even greater than or equal to 1.5 wt %. In embodiments, the amount of metallic stearate catalyst in the article may be less than or equal to 5 wt %, less than or equal to 4.5 wt %, or even less than or equal to 4 wt %. In embodiments, the amount of catalyst in the article may be from 1 wt % to 5 wt %, from 1 wt % to 4.5 wt %, from 1 wt % to 4 wt %, from 1.25 wt % to 5 wt %, from 1.25 wt % to 4.5 wt %, from 1.25 wt % to 4 wt %, from 1.5 wt % to 5 wt %, from 1.5 wt % to 4.5 wt %, or even from 1.5 wt % to 4 wt %, or any and all sub-ranges formed from any of these endpoints. When the amount of metallic stearate catalyst in the article is less than 1 wt %, the article crosslinked such that the article may have severe deformation.

### Article

As described herein, using a metallic stearate catalyst produces an article having crosslinking, as evidenced by sufficient compression set, that may be may be desired in medical, healthcare, and food applications.

In embodiments, the silane crosslinking of the article may be at least one of intramolecular crosslinking of the ethylene-based polymer and intermolecular crosslinking of the polyolefin and ethylene-based polymer.

The ethylene-based polymer and/or the polyolefin has a compression set of 100% at 125° C. Accordingly, a compression set of less than or equal to 90% at 125° C. is indicative of crosslinking. In embodiments, the article may have a compression set less than or equal to 90%, less than or equal to 86%, less than or equal to 84%, less than or equal to 82%, or even less than or equal to 80%, as measured at 125° C.

The ethylene-based polymer and/or the polyolefin has a compression set of 100% at 150° C. Accordingly, a compression set of less than or equal to 95% at 150° C. is indicative of crosslinking. In embodiments, the article may have a compression set less than or equal to 95%, less than or equal to 92%, less than or equal to 90%, or even less than or equal to 88%, as measured at 150° C.

In embodiments, the article may have a hardness greater than or equal to 60 Shore A, greater than or equal to 70 Shore A, or even greater than or equal to 80 Shore A. In embodiments, the article may have a hardness less than or equal to 95 Shore A, less than or equal to 90 Shore A, or even less than or equal to 85 Shore A. In embodiments, the article may have a hardness from 60 Shore A to 95 Shore A, from 60 Shore A to 90 Shore A, from 60 Shore A to 85 Shore A, from 70 Shore A to 95 Shore A, from 70 Shore A to 90 Shore A, from 70 Shore A to 85 Shore A, from 80 Shore A to 95 Shore A, from 80 Shore A to 90 Shore A, or even from 80 Shore A to 85 Shore A, or any and all sub-ranges formed from any of these endpoints.

In embodiments, the article may have a specific gravity greater than or equal to 0.7 or even greater than or equal to 0.8. In embodiments, the article may have a specific gravity less than or equal to 1.2, less than or equal to 1.1, or even less than or equal to 1.0. In embodiments, the article may have a specific gravity from 0.7 to 1.2, from 0.7 to 1.1, from 0.7 to 1.0, from 0.8 to 1.2, from 0.8 to 1.1, or even from 0.8 to 1.0, or any and all sub-ranges formed from any of these endpoints.

In embodiments, the article may have a 100% modulus greater than or equal to 3.5 MPa, greater than or equal to 4.0 MPa, or even greater than or equal to 4.5 MPa. In embodiments, the article may have a 100% modulus less than or equal to 8.5 MPa, less than or equal to 8.0 MPa, or even less than or equal to 7.5 MPa. In embodiments, the article may have a 100% modulus from 3.5 MPa to 8.5 MPa, from 3.5 MPa to 8.0 MPa, from 3.5 MPa to 7.5 MPa, from 4.0 MPa to 8.5 MPa, from 4.0 MPa to 8.0 MPa, from 4.0 MPa to 7.5 MPa, from 4.5 MPa to 8.5 MPa, from 4.5 MPa to 8.0 MPa, or even from 4.5 MPa to 7.5 MPa, or any and all sub-ranges formed from any of these endpoints.

In embodiments, the article may have a tensile strength greater than or equal to 4.5 MPa, greater than or equal to 5.0 MPa, or even greater than or equal to 5.5 MPa. In embodiments, the article may have a tensile strength less than or equal to 8.5 MPa, less than or equal to 8.0 MPa, less than or equal to 7.5 MPa, or even less than or equal to 7.0 MPa. In embodiments, the article may have a tensile strength from 4.5 MPa to 8.5 MPa, from 4.5 MPa to 8.0 MPa, from 4.5 MPa to 7.5 MPa, from 4.5 MPa to 7.0 MPa, from 5.0 MPa to 8.5 MPa, from 5.0 MPa to 8.0 MPa, from 5.0 MPa to 7.5 MPa, from 5.0 MPa to 7.0 MPa, from 5.5 MPa to 8.5 MPa, from 5.5 MPa to 8.0 MPa, from 5.5 MPa to 7.5 MPa, or even from 5.5 MPa to 7.0 MPa, or any and all sub-ranges formed from any of these endpoints.

In embodiments, the article may have a tensile elongation greater than or equal to 150%, greater than or equal to 175%, or even greater than or equal to 200%. In embodiments, the article may have a tensile elongation less than or equal to 525%, less than or equal to 500% or even less than or equal to 475%. In embodiments, the article may have a tensile elongation from 150% to 525%, from 150% to 500%, from 150% to 475%, from 175% to 525%, from 175% to 500%, from 175% to 475%, from 200% to 525%, from 200% to 500%, or even from 200% to 475%, or any and all sub-ranges formed from any of these endpoints.

As exemplified in the Examples section below, the articles described herein comprising a crosslinked reaction product of ethylene-based polymer (e.g., OBC or ethylene-octene copolymer), polyolefin, silane crosslinker, and metallic stearate catalyst are crosslinked, as evidenced by sufficient compression set.

### Plasticizer

In embodiments, the articles described herein may further comprise plasticizer to improve flow.

In embodiments, the plasticizer may comprise triethylene glycol bis (2-ethylhexanoate), triethyleneglycol bis (2-ethylhexanoate), dibutyl sebacate, tetraethylene glycol di-n-heptanoate, dihexyl adipate, dioctyl adipate, hexyl adipates (e.g., cyclohexyl adipate), nonyl adipates, phthalates, phthalate esters, or a combination thereof. In embodiments, the plasticizer may comprise mineral oil, synthetic oil, poly-alpha-olefin, polyethylene copolymer, polyisobutene, or a combination thereof.

In embodiments, the amount of plasticizer in the article may be greater than or equal to 2 wt %, greater than or equal to 4 wt %, or even greater than or equal to 6 wt %. In embodiments, the amount of plasticizer in the article may be less than or equal to 40 wt %, less than or equal to 35 wt %, or even less than or equal to 30 wt %. In embodiments, the amount of plasticizer in the article may be from 2 wt % to 40 wt %, from 2 wt % to 35 wt %, from 2 wt % to 30 wt %, from 4 wt % to 40 wt %, from 4 wt % to 35 wt %, from 4 wt % to 30 wt %, from 6 wt % to 40 wt %, from 6 wt % to 35 wt %, or even from 6 wt % to 30 wt %, or any and all sub-ranges formed from any of these endpoints.

Suitable commercial embodiments of the plasticizer are available under the PURETOL brand, such as 550, from Petro-Canada Lubricants.

### Additives

In embodiments, the article may further comprise an additive. In embodiments, the additive may comprise adhesion promoters; biocides; anti-fogging agents; anti-static agents; blowing and foaming agents; bonding agents and bonding polymers; polar copolymers (e.g., ethylene-vinyl acetate (EVA), ethylene butyl acrylate (EBA), or ethyl methacrylate (EMA)); dispersants; flame retardants and smoke suppressants; mineral fillers; initiators; lubricants; micas; pigments, colorants, and dyes; processing aids; release agents; silanes, titanates, and zirconates; slip and anti-blocking agents; ultraviolet light stabilizer; antioxidants; viscosity regulators; waxes; or a combination thereof.

### Process

In embodiments, the article described herein may be made with a batch process or continuous process.

In embodiments, the components of the article, including the ethylene-based polymer, the polyolefin, and the silane crosslinker, may be added to an extruder (e.g., 27 MM Leistriz Twin Extruder (L/D 52)) and blended. In embodiments, the silane crosslinker is added to the blend such that the ethylene-based polymer is silane grafted. In embodiments, the blending (e.g., in the barrel of the extruder) may be carried out at a temperature from 150° C. to 220° C.

Blending (also known as compounding) devices are well known to those skilled in the art and generally include feed means, especially at least one hopper for pulverulent materials and/or at least one injection pump for liquid materials; high-shear blending means, for example a co-rotating or counter-rotating twin-screw extruder, usually comprising a feed screw placed in a heated barrel (or tube); an output head, which gives the extrudate its shape; and means for cooling the extrudate, either by air cooling or by circulation of water. The extrudate is generally in the form of rods continuously exiting the device and able to be cut or formed into granules. However, other forms may be obtained by fitting a die of desired shape on the output die. For example, in embodiments, the process may comprise profile extrusion including forcing the extrudate through a die cut into the linear shape of the desired finished article (e.g., channel or tube).

In embodiments, the silane-grafted blend may be cured such that the ethylene-based polymer and the polyolefin are silane crosslinked. In embodiments, 1.5 to 10 wt % of the metallic stearate catalyst is blended with the ethylene-based polymer, polyolefin, and the silane crosslinker, during silane grafting. In other embodiments, the metallic stearate catalyst is added at the extrusion step.

### EXAMPLES

Table 1 below shows sources of ingredients for the formulations used to form the articles of Examples E1 to E6.

TABLE 1

| Ingredients | Brand | Source |
|---|---|---|
| OBC | INFUSE 9000 | Dow Chemical Company |
| ethylene-octene | Solumer 851T | SK Chemicals |
| copolymer | | |
| Polypropylene | P4G3Z-039PP | Flint Hills |
| vinyltrimethoxy silane | SILQUEST A-171 | Momentive |
| (silane crosslinker) | | |
| dicumyl peroxide | PERKADOX BC-FF | AkzoNobel |
| (initiator) | | |
| white mineral oil | PURETOL 550 | Petro-Canada Lubricants |
| (plasticizer) | | |

Table 2 below shows the formulations used to form and the certain properties of Examples E1 to E6.

TABLE 2

| | Example | | | | | | | |
|---|---|---|---|---|---|---|---|---|
| | E1 | | E2 | | E3 | | E4 | |
| Ingredient | Parts | Wt % | Parts | Wt % | Parts | Wt % | Parts | Wt % |
| INFUSE 9000 | 100 | 47.97 | 100 | 47.97 | 100 | 47.97 | 100 | 47.97 |
| Solumer 851T | 0 | 0 | 0 | 0 | 0 | 0 | 0 | 0 |
| P4G3Z-039PP | 42.86 | 20.56 | 42.86 | 20.56 | 42.86 | 20.56 | 42.86 | 20.56 |
| SILQUEST A-171 | 3.86 | 1.85 | 3.86 | 1.85 | 3.86 | 1.85 | 3.86 | 1.85 |
| PERKADOX BC-FF | 0.43 | 0.21 | 0.43 | 0.21 | 0.43 | 0.21 | 0.43 | 0.21 |
| PURETOL 550 | 57.14 | 27.41 | 57.14 | 27.41 | 57.14 | 27.41 | 57.14 | 27.41 |
| Zinc Stearate | 4.17 | 2.00 | 0 | 0 | 0 | 0 | 0 | 0 |
| Lithium Stearate | 0 | 0 | 4.17 | 2.00 | 0 | 0 | 0 | 0 |
| Calcium Stearate | 0 | 0 | 0 | 0 | 4.17 | 2.00 | 0 | 0 |
| Sodium Stearate | 0 | 0 | 0 | 0 | 0 | 0 | 4.17 | 2.00 |
| TOTAL | 208.46 | 100.0 | 208.46 | 100.0 | 208.46 | 100.0 | 208.46 | 100.0 |

| | | | | |
|---|---|---|---|---|
| Hardness (Shore A) | 81 | 82 | 83 | 80 |
| Specific gravity | 0.88 | 0.88 | 0.88 | 0.88 |
| 100% modulus (MPa) | 4.91 | 5.22 | 5.56 | 4.60 |
| Tensile strength (MPa) | 6.47 | 6.61 | 7.14 | 5.58 |
| Tensile elongation (%) | 304 | 290 | 234 | 333 |
| Compression set | 79 | 53 | 67 | 61 |
| (125° C., 22 hrs, %) | | | | |
| Compression set | 86 | 59 | 79 | 73 |
| (150° C., 22 hrs, %) | | | | |

As shown in Table 2, Examples E1-E6, articles including metallic stearate catalysts showed sufficient compression set less than 90% at 125° C. and less than 95% at 150° C.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

What is claimed is:

1. An article comprising a crosslinked reaction product of:
olefin block copolymer (OBC);
polyolefin;
silane crosslinker; and
1 to 5 weight percent (wt %) of a metallic stearate catalyst,
wherein the OBC is silane grafted, and
wherein the grafted silane enables at least one of intramolecular silane crosslinking of the OBC and intermolecular silane crosslinking of the OBC and the polyolefin.

2. The article of claim 1, wherein the article comprises 1.25 wt % to 4.5 wt % of the metallic stearate catalyst.

3. The article of claim 1, wherein the metallic stearate catalyst comprises zinc stearate, lithium stearate, calcium stearate, sodium stearate, or a combination thereof.

4. The article of claim 1, wherein the OBC comprises an ethylene alpha-olefin repeating unit.

5. The article of claim 4, wherein the ethylene alpha-olefin repeating unit comprises ethylene-octene copolymer, ethylene-hextene copolymer, ethylene-butene copolymer, or a combination thereof.

6. The article of claim 1, wherein the article comprises 1 wt % to 35 wt % of the polyolefin.

7. The article of claim 1, wherein the polyolefin comprises a propylene-based polyolefin.

8. (canceled)

9. The article of claim 1, wherein the article comprises 0.01 wt % to 4 wt % of the silane crosslinker.

10. The article of claim 1, wherein the silane crosslinker comprises vinyl trialkoxysilane.

11. (canceled)

12. (canceled)

13. (canceled)

14. The article of claim 1, wherein the article further comprises a plasticizer.

15. The article of claim 14, wherein the article comprises 2 wt % to 40 wt % of the plasticizer.

16. (canceled)

17. (canceled)

18. The article of claim 1, wherein the article has a compression set less than or equal to 90% as measured at 125° C.

19. The article of om claim 1, wherein the article has a compression set less than or equal to 95% as measured at 150° C.

20. (canceled)

21. A process for making an article comprising a crosslinked reaction product of olefin block copolymer (OBC), polyolefin, silane crosslinker, and a metallic stearate catalyst, the process comprising the steps of:
grafting the OBC with the silane such that the OBC is silane grafted; and
curing the silane-grafted OBC in the presence of 1 to 5 wt % of the metallic stearate catalyst, such the OBC and the polyolefin are silane crosslinked.

22. An article comprising a crosslinked reaction product of:
an ethylene-based polymer, the ethylene-based polymer comprising polyolefin elastomer (POE), high-density polyethylene (HDPE), low-density polyethylene (LDPE), linear low-density polyethylene (LLDPE), polyethylene, or a combination thereof,
polyolefin;
silane crosslinker; and
1 to 5 weight percent (wt %) of a metallic stearate catalyst,
wherein the ethylene-based polymer is silane grafted, and
wherein the grafted silane enables at least one of intramolecular silane crosslinking of the ethylene-based polymer and intermolecular silane crosslinking of the ethylene-based polymer and the polyolefin.

23. (canceled)

24. (canceled)
